(19) United States
(12) Patent Application Publication
(10) Pub. No.: US 2006/0208994 A1
(43) Pub. Date: Sep. 21, 2006

(54) Method for eliminating residual image and liquid crystal display therefor

(75) Inventors: Min-Chien Kuo, Lugang Township (TW); Chung-Jen Liu, Tianjhong Township (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: AU Optronics Corp.

(21) Appl. No.: 11/374,821

(22) Filed: Mar. 14, 2006

(30) Foreign Application Priority Data
Mar. 15, 2005 (TW) 94107936

(51) Int. Cl. G09G 3/36

(52) U.S. Cl. 345/98

(57) ABSTRACT

A method for eliminating a residual image and Liquid Crystal Display (LCD) therefore is disclosed. The method includes the steps of deactivating the LCD such that the LCD enters a non-active mode; and providing a scan signal, a data signal and a common voltage signal to the LCD wherein the common voltage signal is substantially equal to the data signal.

This application claims the benefit of Taiwan application Serial No. 94107936, filed Mar. 15, 2005, the subject matter of which is incorporated herein by reference.

### BACKGROUND OF THE INVENTION

1. Field of the Invention

The invention relates in general to a method for processing a residual image and Liquid Crystal Display (LCD) therefor, and more particularly to a method for eliminating a residual image and LCD therefor.

2. Description of the Related Art

The LCDs have been widely used in, for example, personal computer monitors, liquid crystal televisions, mobile phones or Personal Digital Assistant (PDAs). The LCDs have been merged into the human life, and the huge business opportunity and market have made the LCD become the star of tomorrow.

FIG. 1 is a circuit diagram showing a pixel in a conventional LCD. A pixel 100 includes a Thin-Film Transistor (TFT) M1, a liquid crystal capacitor Cc1 and a storage capacitor Cs1. The TFT M1 has a gate coupled to a scan line S1 to receive a scan signal Scan1 transmitted through the scan line S1. The liquid crystal capacitor Cc1 has a first terminal coupled to a data line D1 through the TFT M1, and a second terminal for receiving a common voltage signal Vcom1. The storage capacitor Cs1 has a first terminal coupled to the first terminal of the liquid crystal capacitor Cc1, and a second terminal for receiving the common voltage signal Vcom1. When the scan signal Scan1 turns on the TFT M1, a data signal Data1 is transmitted to the first terminal of the liquid crystal capacitor Cc1 and the first terminal of the storage capacitor Cs1 through the data line D1 and the TFT M1.

When the LCD enters a power-saving mode, a standby mode or a shutdown mode, the phenomenon of a residual image tends to occur at the beginning when the LCD enters each of the above-mentioned modes because different charges are still stored in the storage capacitor Cs1 and the liquid crystal capacitor Cc1 of each pixel and the orientations of the liquid crystal molecules are thus influenced. In order to reduce the influence of the residual image, the conventional method is to enable the medium-size and small-size LCDs to display white frames so as to reduce the phenomenon of the residual image. FIG. 2 is a timing diagram of a data signal, a common voltage signal and a scan signal in the prior art. The data driver generates the data signal Data1 according to a RGB signal. Because the data driver has a sample & hold buffer, the data signal Data1 is delayed with respect to the RGB signal. Before the time instant t1, the LCD displays a frame normally. At the time instant t1, the LCD enters the power-saving mode, the standby mode or the shutdown mode. After the time instant t1, the data signal Data1 and the common voltage signal Vcom1 are held to have a constant voltage difference and make the LCD display the white frame in order to avoid the phenomenon of the residual image. After the time instant t2, the LCD stops outputting the white frame, and the data signal Data1 and the common voltage signal Vcom1 become zero potentials. At this time, the TFT M1 is turned off such that the charges in the storage capacitor Cs1 and the liquid crystal capacitor Cc1 for displaying the white frame only can be removed slowly via the adjacent parasitic resistors. Because the speed of removing the charges of the storage capacitor Cs1 and the liquid crystal capacitor Cc1 is too low, the liquid crystal molecules can only return to have the pre-tilt angles occurring when no charge is stored in the storage capacitor Cs1 and the liquid crystal capacitor Cc1 after a period of time has been elapsed. Thus, the user still sees a gray residual image to show up and gradually disappear on the LCD. Consequently, the conventional method cannot really solve the problem of the residual image.

### SUMMARY OF THE INVENTION

It is therefore an object of the invention to provide a method for eliminating a residual image and LCD therefore, such that the capacitor in the pixel quickly discharges to overcome the problem of the residual image when the LCD enters a power-saving mode, a standby mode or a shutdown mode.

The invention achieves the above-identified object by providing a method for eliminating a residual image in a LCD. The method includes the steps of deactivating the LCD such that the LCD enters a non-active mode; and providing a scan signal, a data signal and a common voltage signal to the LCD wherein the common voltage signal is substantially equal to the data signal.

The invention also achieves the above-identified object by providing a LCD comprising a plurality of pixels for eliminating a residual image. The LCD includes a thin film transistor (TFT) and a liquid crystal capacitor. The TFT has a gate for receiving a first scan signal. The liquid crystal capacitor has a first terminal for receiving a data signal through the TFT, and a second terminal for receiving a common voltage signal. When the LCD enters a non-active mode, the common voltage signal substantially equals the data signal.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a circuit diagram showing a pixel in a conventional LCD.

FIG. 2 is a timing diagram of a data signal, a common voltage signal and a scan signal in the prior art.

FIG. 3 is a schematic illustration showing a LCD for eliminating a residual image according to a preferred embodiment of the invention.

FIG. 4 is an equivalent circuit diagram showing a pixel of a LCD according to a first embodiment of the invention.

FIG. 5 is an equivalent circuit diagram showing a pixel of a LCD according to a second embodiment of the invention.

FIG. 6 is a timing diagram of a data signal, a common voltage signal and a scan signal according to the preferred embodiment of the invention.

FIG. 7 is a flow chart showing a method for eliminating a residual image according to the preferred embodiment of the invention.

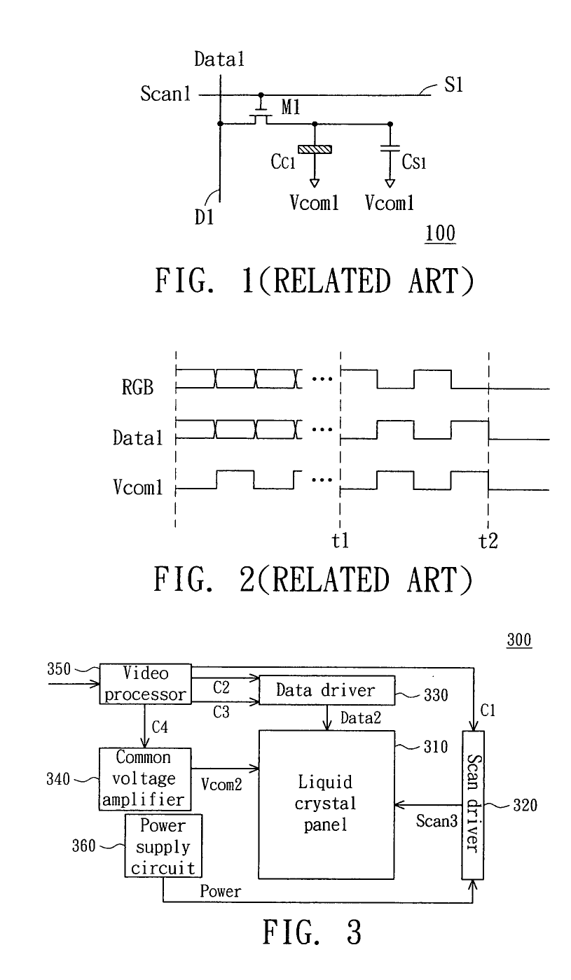

### DETAILED DESCRIPTION OF THE INVENTION

FIG. 3 is a schematic illustration showing a LCD for eliminating a residual image according to a preferred embodiment of the invention. The LCD 300 can eliminate the phenomenon of a residual image when it enters a non-active mode, such as a power-saving mode, a standby mode or a shutdown mode. The LCD 300 includes a liquid crystal panel 310, a scan driver 320, a data driver 330, a common voltage amplifier 340, a video processor 350, and a power supply circuit 360. The video processor 350 performs a video processing procedure and then outputs a control signal C1, a control signal C2, a color signal C3 and a common voltage control signal C4. The color signal C3 may be, for example, a RGB signal. The video processor 350 includes an image processor, a RGB processor, a timing controller, a Pulse Width Modulation (PWM) controller and an Inter-Integrated Circuit (I2C) bus.

The scan driver 320 outputs a scan signal Scan3 according to the control signal C1. The data driver 330 outputs a data signal Data2 according to the control signal C2 and the color signal C3. That is, the data signal Data2 is generated according to the color signal C3. Because of the processing function of the sample & hold buffer of the data driver 330, the data signal Data2 has a delay with respect to the color signal C3. The common voltage amplifier 340 outputs a common voltage signal Vcom2. The power supply circuit 360 provides an operation voltage Power, which includes operation voltages VGH and VGL, to the scan driver 320, such that the scan driver 320 can output a turn-on voltage (VGH) and a turn-off voltage (VGL) for the TFT. The liquid crystal panel 310 displays a frame according to the scan signal Scan3, the data signal Data2 and the common voltage signal Vcom2.

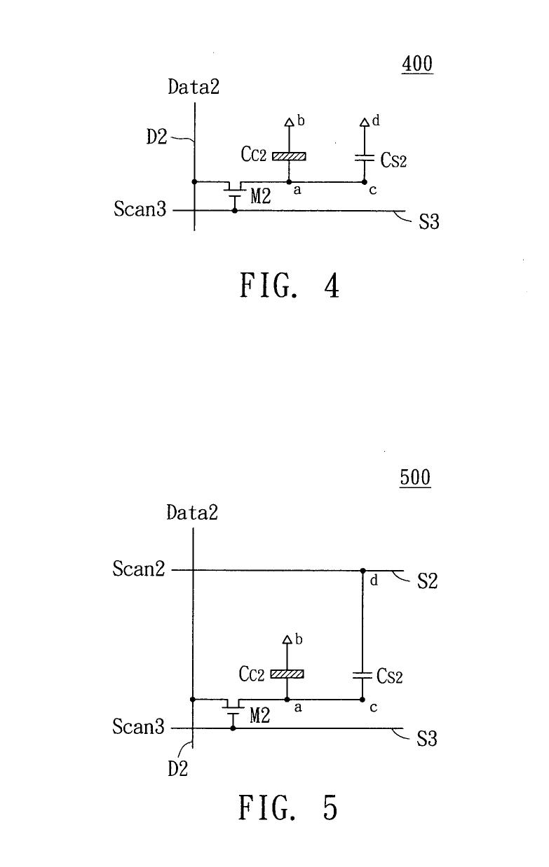

FIG. 4 is an equivalent circuit diagram showing a pixel of a LCD according to a first embodiment of the invention. The liquid crystal panel 310 includes a pixel 400, which includes a TFT M2, a liquid crystal capacitor Cc2 and a storage capacitor Cs2. The TFT M2 has a gate for receiving the scan signal Scan3 through a scan line S3. The liquid crystal capacitor Cc2 has a terminal “a” for receiving the data signal Data2 through the TFT M2 and a data line D2, and a terminal “b” for receiving the common voltage signal Vcom2. When the LCD 300 enters the non-active mode, the common voltage signal Vcom2 and the color signal C3 are controlled such that the common voltage signal Vcom2 substantially equals the data signal Data2, or the Vcom2 and the Data2 approach a zero potential. The storage capacitor Cs2 has a terminal “c” electrically connected to the terminal “a” of the liquid crystal capacitor Cc2, and a terminal “d” for receiving the common voltage signal Vcom2. After the LCD 300 enters the non-active mode, the scan signal Scan3 outputs a pulse in the first frame period to turn on the TFT M2, and the liquid crystal capacitor Cc2 and the storage capacitor Cs2 discharge through the turned-on TFT M2 and the data line D2, or through the terminal “b” of the liquid crystal capacitor Cc2 and the terminal “d” of the storage capacitor Cs2. Thus, the charges stored in the liquid crystal capacitor Cc2 and the storage capacitor Cs2 can be reduced quickly.

FIG. 5 is an equivalent circuit diagram showing a pixel of a LCD according to a second embodiment of the invention. The difference between the pixel 500 of the second embodiment and the pixel 400 of the first embodiment is that the terminal “d” of the storage capacitor Cs2 of the pixel 500 is coupled to a scan line S2 for a previous row of pixels and receives a scan signal Scan2 but not the common voltage signal Vcom2. In this embodiment, however, when the TFT M2 is turned on, the scan signal Scan2 has a voltage equal to the turn-off voltage. If the data signal Data2 substantially equals the zero potential, and the Vcom2 has also the zero potential, the discharging effects of the storage capacitor Cs2 and the liquid crystal capacitor Cc2 are better.

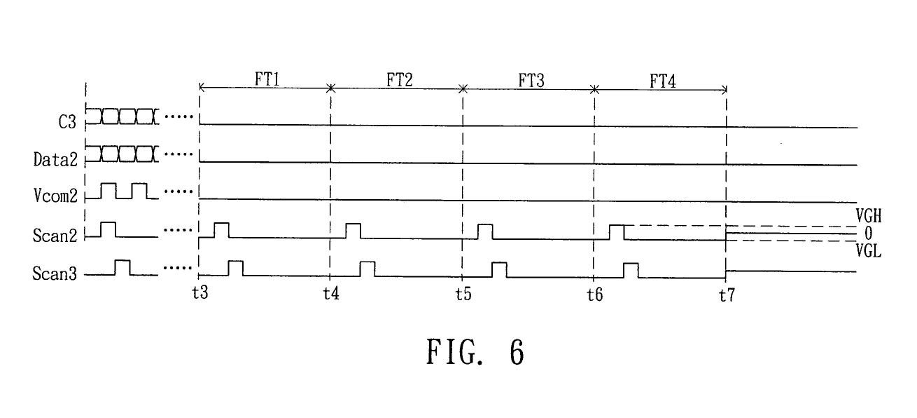

FIG. 6 is a timing diagram of a data signal, a common voltage signal and a scan signal according to the preferred embodiment of the invention. The duration from the time instant t3 to the time instant t4 represents the first frame period FT1 after the LCD enters the non-active mode, and the frame periods FT2, FT3 and FT4 range from the time instant t4 to the time instant t5, from the time instant t5 to the time instant t6, and from the time instant t6 to the time instant t7, respectively. Each of the frame periods FT2 to FT4 is the time for the LCD 300 to display a frame. For example, if the LCD 300 has a display frequency of 60 Hz, one frame period equals 1/60 seconds. In the continuous three frame periods (i.e., the frame periods FT2, FT3 and FT4) after the frame period FT1 of the LCD 300, the scan signal Scan3 provides a pulse to turn on the TFT M2 and to enable the liquid crystal capacitor Cc2 and the storage capacitor Cs2 to discharge the stored charges through the turned-on TFT M2 and the data line D2 quickly. When the LCD 300 enters the non-active mode after the time instant t3, the data signal Data2 and the common voltage signal Vcom2 have substantially the same voltage, such that the voltage drop between the liquid crystal capacitor Cc2 and the storage capacitor Cs2 is zero and the discharging procedure is performed quickly. In FIG. 6, the data signal Data2 and the common voltage signal Vcom2 having a zero potential are described as an example. When the discharging operations of the liquid crystal capacitor Cc2 and the storage capacitor Cs2 terminate (i.e., after the time instant t7), the LCD 300 stops outputting the scan signal Scan2, the data signal Data2 and the common voltage signal Vcom2, and the liquid crystal panel 310 does not display a frame and no residual image exists. That is, after the time instant t7, the video processor 350 stops outputting the color signal C3, which is a certain voltage level or a zero potential, the first control signal C1, the second control signal C2 containing the Data Clock, the PWM signal and the common voltage control signal C4. The common voltage signal Vcom2 may be a certain voltage level having the same potential as the Data2 or a zero potential, wherein the Data Clock may not be stopped.

The data signal Data2 and the common voltage signal Vcom2 may also be square waves with the same amplitude, the same frequency and the same phase, or have the same low voltage. It only needs that when the scan signal Scan3 turns on the TFT M2, the data signal Data2 and the common voltage signal Vcom2 have no voltage difference such that the liquid crystal capacitor Cc2 and the storage capacitor Cs2 can have zero voltage drop. It is unnecessary to terminate the discharge procedure in continuous three frame periods after the first frame period as long as the charges stored in the liquid crystal capacitor Cc2 and the storage capacitor Cs2 can be removed to be substantially zero within the accumulated frame period of the scan signal Scan3 having a pulse. For example, it is possible to achieve the object of the invention only by providing a scan signal Scan3 of a pulse within the first frame time FT1 or providing a scan signal Scans respectively in the first frame time FT1 and the frame time FT2.

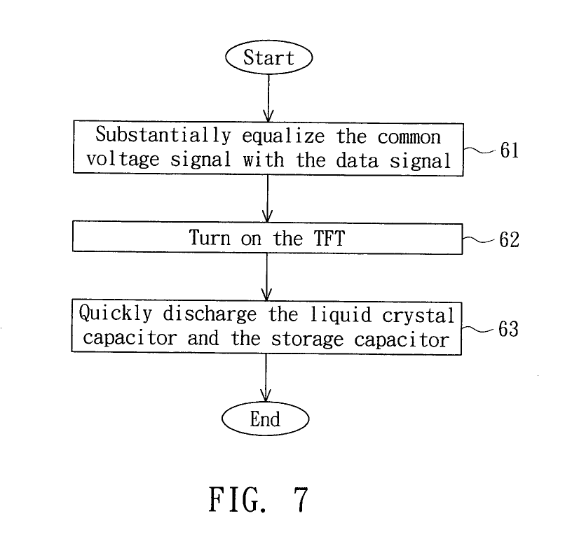

FIG. 7 is a flow chart showing a method for eliminating a residual image according to the preferred embodiment of the invention. First, after the LCD 300 enters the non-active mode, the common voltage signal Vcom2 and the data signal Data2 are controlled to be substantially equal to each other, as shown in step 61. Then, in one frame period, a scan signal Scan3 of a pulse is provided to the gate of the TFT M2, such that the TFT M2 is turned on, as shown in step 62. The liquid crystal capacitor Cc2 and the storage capacitor Cs2 are discharged through the turned-on TFT M2 and the data line D2, or through the terminal “b” of the liquid crystal capacitor Cc2 and the terminal “d” of the storage capacitor Cs2, such that the charges stored in the liquid crystal capacitor Cc2 and the storage capacitor Cs2 are decreased quickly, as shown in step 63.

The LCD and the method of eliminating the residual image according to the embodiments of the invention can completely solve the problem of the residual image without an additional discharge circuit being added to achieve the object of discharging, so no additional cost has to be paid. Changing the states of the data signal, the scan signal and the common voltage signal can quickly discharge the liquid crystal capacitor and the storage capacitor.

While the invention has been described by way of examples and in terms of preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A method for eliminating a residual image in a liquid crystal display (LCD), comprising the steps of:
deactivating the LCD such that the LCD enters a non-active mode; and
providing a scan signal, a data signal and a common voltage signal to the LCD, wherein the common voltage signal substantially equals to the data signal.

2. The method according to claim 1, wherein the non-active mode is a power-saving mode, a standby mode or a shutdown mode.

3. The method according to claim 1, wherein the scan signal comprises a pulse signal.

4. The method according to claim 1, wherein the data signal and the common voltage signal have a substantially zero potential.

5. The method according to claim 1, wherein the data signal and the common voltage signal are square waves with the same amplitude, frequency and phase.

6. The method according to claim 1, wherein the step of providing the scan signal, the data signal and the common voltage signal is performed for a plurality of frame periods.

7. The method according to claim 1, further comprising the step of:
stopping transmitting the scan signal, the data signal and the common voltage signal.

8. A liquid crystal display (LCD) comprising a plurality of pixels for eliminating a residual image, comprises:
a thin film transistor (TFT) having a gate for receiving a first scan signal; and
a liquid crystal capacitor having a first terminal for receiving a data signal through the TFT, and a second terminal for receiving a common voltage signal,
wherein the common voltage signal substantially equals the data signal when the LCD enters a non-active mode.

9. The LCD according to claim 8, wherein the non-active mode is a power-saving mode, a standby mode or a shutdown mode.

10. The LCD according to claim 8, wherein the scan signal comprises a pulse signal.

11. The LCD according to claim 8, wherein the data signal and the common voltage signal have a substantially zero potential.

12. The LCD according to claim 8, wherein the data signal and the common voltage signal are square waves with the same amplitude, frequency and phase.

13. The LCD according to claim 8, wherein the liquid crystal display is adapted to receive the scan signal, the data signal and the common voltage signal for a plurality of frame periods.

14. The LCD according to claim 8, further comprises a storage capacitor having a first terminal electrically connected to the first terminal of the liquid crystal capacitor, and a second terminal for receiving a reference voltage signal.

15. The LCD according to claim 14, wherein after the LCD enters the non-active mode, the first scan signal has a pulse within a frame period such that the TFT is turned on and the liquid crystal capacitor and the storage capacitor discharge through the turned-on TFT.

16. The LCD according to claim 14, wherein the reference voltage signal is the common voltage signal.

17. The LCD according to claim 14, wherein the reference voltage signal is a second scan signal, and the second scan signal is a scan signal for driving a previous row of pixels.
